(19) United States
(12) Patent Application Publication
(10) Pub. No.: US 2004/0087230 A1
(43) Pub. Date: May 6, 2004

(54) Shoe manufacturing and recycling system

(76) Inventor: Martin Wildeman, Spartanburg, SC (US)

Correspondence Address: James M. Robertson, Robertson & Mullinax, LLC, P O Box 26029, Greensville, SC, 29616-1029, US

(21) Appl. No.: 10/631,127

(22) Filed: Jul. 31, 2003

Related U.S. Application Data
(60) Provisional application No. 60/415,392, filed on Oct. 2, 2002.
(60) Provisional application No. 60/401,159, filed on Aug. 5, 2002.

(51) Int. Cl. B29B 17/00; D01D 1/02; D02G 3/36

(52) U.S. Cl. 442/172; 264/103; 264/136; 264/153; 264/37.32; 264/171.13; 428/196; 442/395; 442/287

(57) ABSTRACT

A polymeric fibrous base textile with a chemically compatible hot melt coating disposed across the base textile is provided. The coating is present in an amount and is of a composition such that upon application of heat and pressure the coating may be melt bonded to a second surface material thereby establishing a bond between the base textile and the second surface material. In addition, the concentration and composition of the coating are such that scrap portions of the base textile including the coating may be directly reprocessed by shredding and melting to yield a fiber grade material suitable for fiber formation and reprocessing back into a suitable base textile.

### CROSS-REFERENCE TO RELATED APPLICATIONS

This application claims priority from and benefit of prior provisional application 60/415,392 having a filing date of Oct. 2, 2002 and prior provisional application 60/401,159 having a filing date of Aug. 5, 2002 the contents of all of which are hereby incorporated by reference as if fully set forth herein. the benefit

### FIELD OF THE INVENTION

The present invention relates to a comprehensive system for the production, use and recycling of textile materials suitable in the construction of shoes. More particularly, various aspects of the invention relate to textile materials incorporating heat activated coatings for use in shoe assembly, equipment and related techniques adapted to facilitate attachment of such textile materials to other materials during shoe assembly and to a textile production and regeneration system adapted to reduce waste through enhanced recyclability.

### BACKGROUND OF THE INVENTION

Most athletic footwear is produced with textile materials at various portions of the shoe. Such textile materials may take many forms including woven and knitted constructions as well as nonwoven constructions such as stitch bonded constructions, felted constructions, spun bonded constructions and the like as will be well known to those of skill in the art. The particular construction of material utilized depends upon the function to be performed within the shoe. By way of example only, if the textile is to be used in an area such as a vamp lining or the like to prevent stretch, distortion and abrasive wear to the shoe during use, a textile material of relatively high strength such as a woven or stitch bonded construction may be desirable. Of course lower strength materials may be used in portions of the shoe where strength is not as critical. Regardless of the actual textile construction used, the textile material is generally formed from a coordinated arrangement of polymeric fibers. Textile materials formed predominantly of polyester fibers have been found to be particularly useful in the manufacture of athletic footwear due to the durability and relatively low cost of such polymeric constituents.

During the shoe manufacturing process it is often necessary to affix a textile material to a second surface such as foam, leather or another textile thereby giving rise to a multi-layer composite construction. Typically, the textile is held to the second surface by stitching or other substantially permanent attachment techniques. However, before such permanent attachment techniques may be applied, it is necessary to mate the textile in proper spatial relation to the second surface and to maintain this spatial relation until the permanent attachment can be completed.

In the past, textile materials in the form of a vamp lining have been attached to the upper material of the shoe by a pressure sensitive adhesive coating that is previously applied to the textile. Usually, this coating is applied to the fabric in continuous roll form. A silicone coated release paper is applied to the coated fabric in order to encapsulate the pressure sensitive coating.

During shoe production the rolls of textile material are die-cut into blanks of desired geometric shape for use in the shoe. The release paper is peeled away from the coating and the textile blank with sticky coating is adhered by hand to the desired second surface material. Unfortunately, the geometry of the components making up a shoe is such that substantial portions of textile material are typically lost during the cutting of the textile blanks. In general, it has been estimated that approximately 20-30% of the textile material may be wasted. Because the textile material is contaminated with sticky adhesive and silicone coated paper, the cutting waste cannot be recycled to form new fiber. Thus, these materials are typically either incinerated or are sent to a landfill.

### SUMMARY OF THE INVENTION

The present invention provides advantages and alternatives over the prior art by providing materials, equipment and processes which permit the replacement of the pressure sensitive adhesive coating with a hot melt (thermoplastic) coating such as a co-polyester which is fully compatible with a base textile material so as to permit unused portions of the coated textile to be recycled back into a useable fiber without substantial treatment.

According to one aspect of the invention, a system of a polymeric fibrous base textile with a chemically compatible hot melt coating disposed in a disperse arrangement across the base textile is provided. The coating is present in an amount and is of a composition such that upon application of heat and pressure such as in a hot press or the like, the hot melt coating may be melt bonded to a second surface material thereby establishing a bond between the base textile and the second surface material. In addition, the concentration and composition of the coating are such that scrap portions of the base textile including the coating may be directly reprocessed by shredding and melting to yield a fiber grade material suitable for fiber formation and reprocessing back into a suitable base textile.

According to another aspect of the invention, a modular processing station is provided for the efficient adhesion of multiple precut blanks of the coated base textile to complimentary precut panels of a second surface material so as to establish at least a temporary bonded relation between the base textile material and the second surface material.

According to still a further aspect of the invention, a comprehensive process for the production, coating, use and recycling of polymeric fiber based textile material is provided to permit the substantially complete recycling of unused portions of the coated textile material back into a fiber for production of a useable textile material.

### BRIEF DESCRIPTION OF THE DRAWINGS

The present invention will now be described by way of example only, with reference to the accompanying drawings which constitute a part of the specification herein and in which:

FIG. 1 is a perspective view of a shoe;

FIG. 2 is an elevation view of a coated textile material;

FIG. 3 is a side view taken generally long line 3-3 in FIG. 2;

FIG. 4 is a process flow diagram illustrating steps of an integrated program of production, use and recycling of a textile material in a shoe manufacturing process;

FIG. 5 is a view of a rotatable table workstation; and

FIG. 6 is a view similar to FIG. 5 illustrating a hot press disposed in pressure applying relation to one hemisphere of the table work station.

While the invention has been illustrated and generally described above and will hereinafter be described in connection with certain potentially preferred embodiments procedures and practices, it is to be understood that in no event is the invention to be limited to such illustrated and described embodiments procedures and practices. On the contrary, it is intended that the present invention shall extend to all alternatives and modifications as may embrace the principles of this invention within the true spirit and scope thereof.

### DESCRIPTION OF PREFERRED EMBODIMENTS

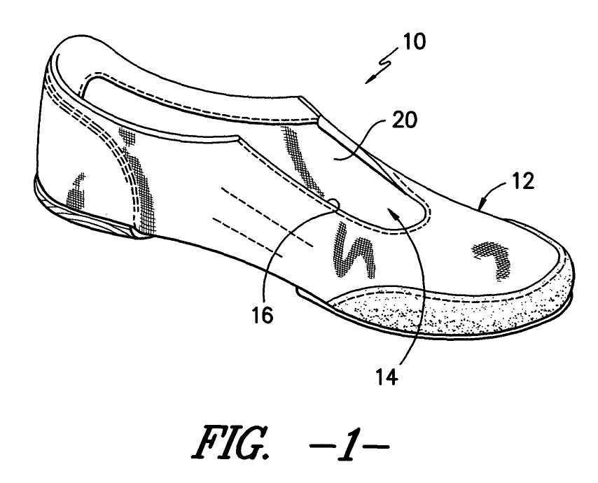

Turning now to the drawings, in FIG. 1 there is illustrated a shoe 10 including an upper 12 and an interior 14. In the illustrated construction an elongated slot opening 16 extends at least partially along the upper 12 to permit tightening adjustment by laces or strap elements (not shown) as will be well known to those of skill in the art. A structural vamp lining 20 including a coated base of textile material is adhere in adjoined relation to the upper 12. The upper 12 is formed of material such as textile fabric, plastic, natural or synthetic leather or the like as will be well known to those of skill in the art. Other portions of textile material of either the same or different construction may be joined to other surfaces within the shoe 10 such as at the heel, the insole, etc.

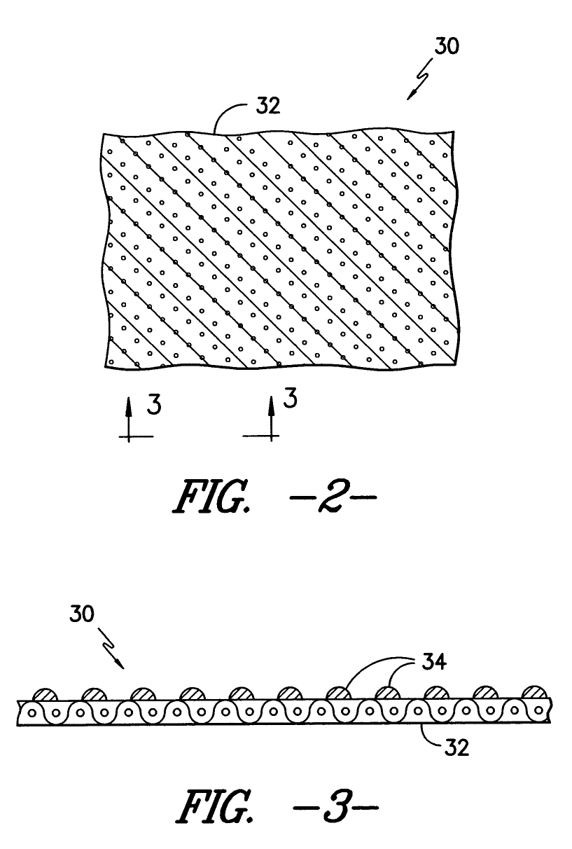

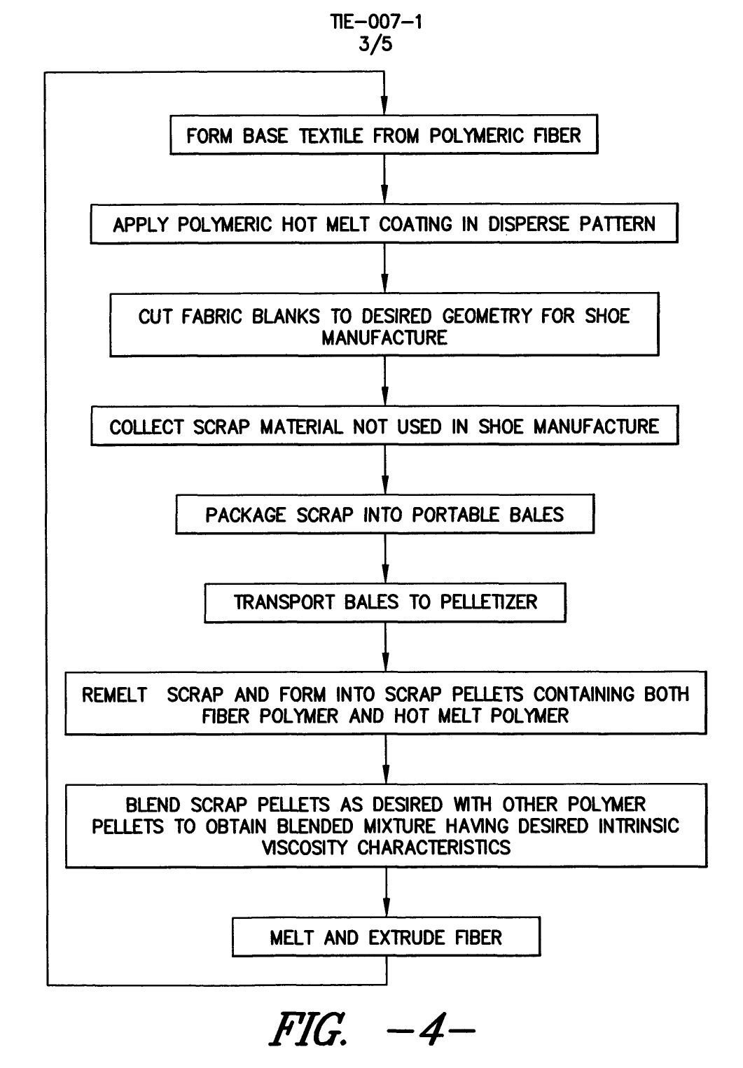

According to one exemplary practice, it is contemplated that the textile material forming the vamp lining 20 and/or other portions of the shoe 10 may be formed from a coated substrate 30 (FIG. 2) including a base textile 32 of polyester fiber constituents and a disperse coating of hot melt co-polyester adhesive 34 (FIG. 3) disposed in a discrete pattern across one side of the base textile. It is contemplated that the base textile 32 may be of any suitable construction including by way of example only and not limitation, a woven fabric, a knit fabric or a nonwoven material such as a needle punched material, stitch bonded fabric or the like as may be known. The polyester fiber making up the base fabric 32 is preferably formed predominantly from purified terephthalic acid (PTA) and is characterized by an intrinsic viscosity such that it is suitable for fiber spinning according to standard fiber formation practices.

The co-polyester adhesive 34 is preferably a polymerized blend of PTA and an effective amount of purified isophthalic acid (PIA) so as to yield an intrinsic viscosity and glass transition temperature which is less than the intrinsic viscosity and glass transition temperature of the polyester fiber forming the base textile 32. According to one contemplated practice, a blend incorporating approximately 30% PIA may be used to produce the co-polyester adhesive 34.

PIA is an isomer of PTA having the same molecular weight. Thus it has been found that the addition of PIA in selected amounts may be used to attain slightly different structural characteristics without altering the overall atomic makeup. The present invention utilizes this selective chemical alteration to develop a system of textile substrate and adhesive which is both effective in providing adhesion of the base textile 32 to an opposing surface and which is also fully recyclable back to fiber form without any special processing.

When the two monomers (PTA and PIA) are blended in the polymerization process, then blended polymer characteristics are observed. Normally, for every percentage point of PIA blended with PTA, a 2.5 degree C. drop in melting point of the resulting polyester polymer is obtained. However, the molecular weight of the polymer blend is essentially unchanged. Moreover, there is no significant effect of modification on color or strength of the product. Thus, it has been found that by incorporating PIA, the melting point can be incrementally reduced until the melt characteristics are such that the resulting copolymer composition may be used as a heat activated bonding agent. At the same time, the atomic structure of the entire system (base textile plus coating) remains substantially unaltered.

As will be appreciated, in order to be effective as a heat activated bonding agent, the copolyester forming the adhesive coating 34 must have a glass transition temperature which is sufficiently lower than the glass transition temperature of the polyester fiber forming the base textile 32 such that the copolyester adhesive 34 may be selectively melted under heat and adhered to an opposing surface without degrading the base fabric 32. A melting point in the range of about 155 degrees C. to about 230 degrees C. (most preferably about 190 degrees C.) may be preferred.

Surprisingly, it has been found that by utilizing a co-polyester adhesive with an appropriate PIA addition, scrap portions of the coated substrate 30 are suitable for direct remelting and processing into pellets and thereafter into fiber without the need to either remove the coating adhesive 34 or otherwise substantially treat the material. Thus, there is the ability to substantially completely recycle all of the coated substrate 30.

In order to promote the processability of the recycled material in a fiber spinning process, it is believed that the process melt of polyester polymer at the fiber spinning process is preferably characterized by an intrinsic viscosity in the range of about 0.52 dl/g or above and is most preferably in the range of about 0.64 dl/g or above. Surprisingly, it has been found that by proper selection of the co-polyester coating composition and add-on level, that this preferred intrinsic viscosity range may be maintained in a recycling process.

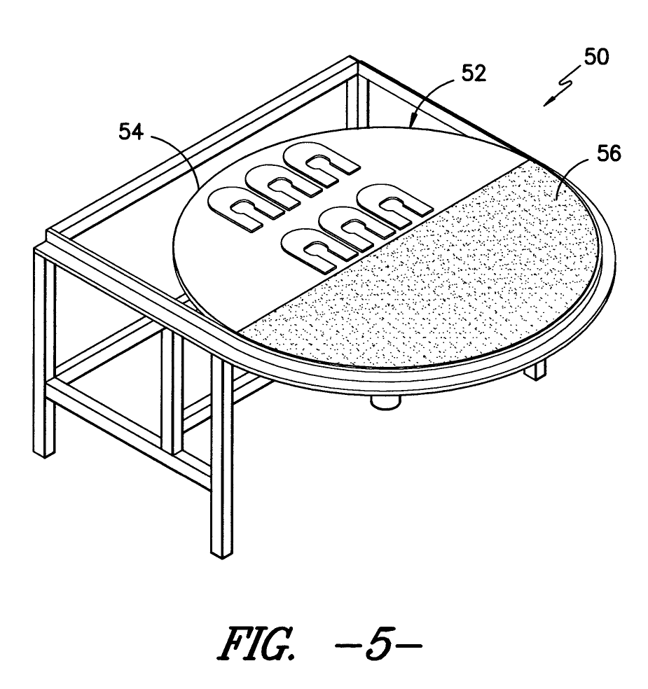

By way of example only, and not limitation, FIG. 4 outlines the steps of one contemplated integrated process for the manufacture, use and recycling of a textile material for use in the manufacture of footwear. As illustrated, in this process a base textile such as a woven, knitted or nonwoven construction such as stitch bonded, needle punched, spunbonded or other textile construction is formed from a polymeric fiber such as polyester fiber in a manner as will be well known to those of skill in the art.

Following formation of the base textile, a hot melt coating as described above is preferably applied across at least one side in a substantially disperse pattern. While a disperse pattern in the form of discrete dots is illustrated, it is likewise contemplated that other patterns including stripes, crosshatching, serpentine patterns and the like may likewise be utilized. Use of a disperse pattern may be beneficial in reducing any substantial stiffening of the base textile thereby promoting pliability during subsequent shoe manufacturing steps. As will be appreciated, these manufacturing steps may include cutting out blanks of the coated material for use in shoe manufacture and the collection of the scraps which are not used. The use of a disperse pattern also reduces the weight of co-polyester adhesive which enters the system so as to reduce the impact of the co-polyester adhesive on recycling.

According to one contemplated process, bales of scrap including the coating may be transported to a pelletizer at which the scrap is remelted and formed into scrap pellets for further processing. As will be appreciated, these scrap pellets will contain a blend of the polyester fiber which made up the original base textile as well as a relatively small percentage the co-polyester hot melt polymer including the PIA addition used as the coating. Accordingly, the intrinsic viscosity of the scrap pellets will be slightly less than that of the fiber making up the original base textile. Despite this difference, due to the relatively small quantity of the co-polyester hot melt adhesive, it has been found that the overall intrinsic viscosity is typically altered only modestly from the levels of the original base textile with the reduction being typically about on the order of about 2.5%. Thus, it is believed that in most instances it is possible, if desired, to process the scrap pellets directly back into fiber for formation of a new base textile.

As will be appreciated, as the production and recycling process is repeated numerous times, the percentage of hot melt co-polyester polymer will tend to increase at each iteration thereby further altering the intrinsic viscosity. In addition, in a completely closed loop system, while the percentage of scrap produced remains the same at each iteration, the overall quantity of scrap produced is reduced. In order to address these issues, according to the illustrated process it is contemplated that prior to fiber extrusion the scrap pellets may be blended with pellets of polyester which do not contain the hot melt co-polyester. The pellets which are blended in may be virgin polymer, recycled from some other source or a mixture of virgin and recycled material. As will be appreciated, such controlled blending thus permits the intrinsic viscosity of the fiber extrusion polymer melt to be controlled with a high degree of precision while at the same time avoiding a potentially undesirable buildup of the hot melt co-polyester polymer. Of course, this blending operation may also be eliminated if desired provided the overall intrinsic viscosity is within the desired limits.

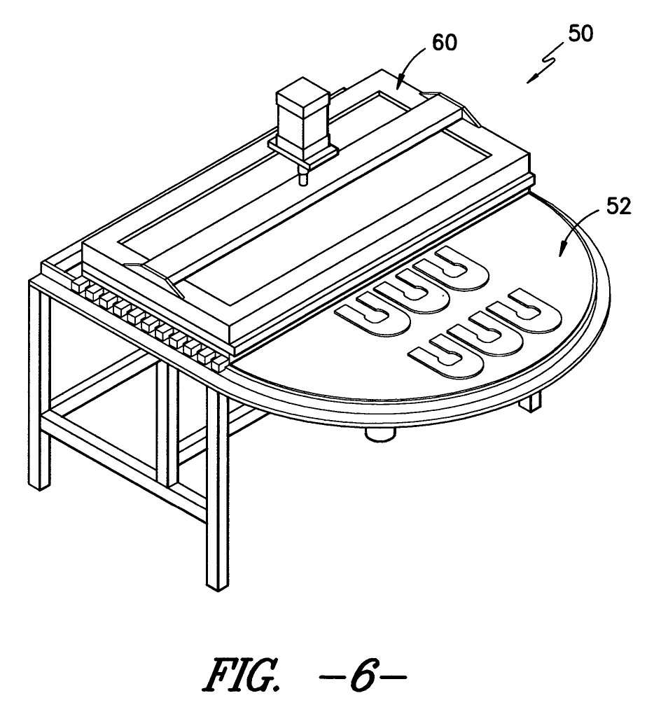

As previously indicated, during the actual shoe manufacturing process the blanks of material cut from the coated substrate may be adhered in bonded juxtaposed relation to other surfaces such as leather, plastic, fabric, foam and the like to make up multi-layered structures suitable for formation into portions of a shoe. By way of example only, and not limitation, a modular assembly station for use in bonding blanks of the coated substrate to other structures is illustrated in FIGS. 5 and 6. As illustrated, the assembly station 50 includes a large turntable work top 52 divided into two substantially identical hemispheres 54, 56. During operation, one or more operators places parts for lamination such as shoe uppers or the like in a pattern across one of the hemispheres. The precut blanks of coated substrate material are thereafter placed on top of these parts in a desired spatial relation with the hot melt adhesive copolyester oriented in sandwiched relation between the layers. The work top 52 is then rotated through a 180 degree angle and a hot plate 60 is activated to apply heat and pressure to the arranged parts. According to one contemplated construction, the surface of the work top 52 may be covered with a silicone rubber mat so as to disperse pressure evenly and avoid irregularities in pressure and heat application. During the application of the hot plate 60, an arrangement of parts for lamination may be placed across the free hemisphere. Upon completion of the laminating process, the work top 52 is rotated again and the laminated parts are removed. The process is thereafter repeated. A substantially continuous process for the placement and lamination of the layers of material is thus provided.

While the present invention has been illustrated and described in relation to certain potentially preferred embodiments and practices, it is to be understood that the illustrated and described embodiments and practices are illustrative only and that the present invention is in no event to be limited thereto. Rather, it is fully contemplated that modifications and variations to the present invention will no doubt occur to those of skill in the art upon reading the above description and/or through practice of the invention. It is therefore intended that the present invention shall extend to all such modifications and variations which incorporate the broad aspects of the present invention within the full spirit and scope of the following claims and all equivalents thereto.

What is claimed is:

1. A textile substrate adapted for use in the manufacture of footwear, the textile substrate comprising a base textile layer and a thermoplastic coating disposed across at least a portion of the base textile layer, wherein the base textile layer comprises at least a percentage of polyester fibers, said polyester fibers having a first glass transition temperature and wherein the thermoplastic coating is a co-polyester having a second glass transition temperature below the first glass transition temperature.

2. The invention as recited in claim 1, wherein the thermoplastic coating is disposed across the base textile layer in a disperse pattern.

3. The invention as recited in claim 1, wherein said polyester fibers consist essentially of a polyester polymer having a substantially equivalent molecular weight to the thermoplastic coating.

4. The invention as recited in claim 3, wherein the thermoplastic coating is disposed across the base textile layer in a disperse pattern.

5. The invention as recited in claim 3, wherein said polyester fibers comprise a first polyester polymer and wherein the thermoplastic coating comprises a blend of said first polyester polymer in combination with an effective amount of an isomer of said first polyester polymer such that the thermoplastic coating is characterized by a melting point in the range of about 155 degrees C. to about 230 degrees C.

6. The invention as recited in claim 5, wherein the thermoplastic coating is disposed across the base textile layer in a disperse pattern.

7. The invention as recited in claim 5, wherein the textile substrate comprising the base textile layer and the thermoplastic coating is characterized by an overall intrinsic viscosity of about 0.52 dl/g or greater under melted conditions.

8. The invention as recited in claim 5, wherein the textile substrate comprising the base textile layer and the thermoplastic coating is characterized by an overall intrinsic viscosity of about 0.64 dl/g or greater under melted conditions.

9. The invention as recited in claim 8, wherein the first polyester polymer is a terephthalic acid polyester polymer.

10. The invention as recited in claim 9, wherein the thermoplastic coating comprises a blend of a terephthalic acid polyester polymer in combination with an isophthalic acid polyester polymer.

11. The invention as recited in claim 10, wherein the thermoplastic coating comprises about 30 percent of said isophthalic acid polyester polymer.

12. The invention as recited in claim 1, wherein the textile substrate comprising the base textile layer and the thermoplastic coating is characterized by an overall intrinsic viscosity of about 0.52 dl/g or greater under melted conditions.

13. The invention as recited in claim 1, wherein the textile substrate comprising the base textile layer and the thermoplastic coating is characterized by an overall intrinsic viscosity of about 0.64 dl/g or greater under melted conditions.

14. A shoe vamp lining textile substrate comprising a base textile layer and a thermoplastic coating disposed in a disperse pattern across at least a portion of the base textile layer, wherein the base textile layer comprises at least a percentage of polyester fibers, said polyester fibers having a first glass transition temperature and wherein the thermoplastic coating is a co-polyester having a second glass transition temperature below the first glass transition temperature, and wherein the textile substrate comprising the base textile layer and the thermoplastic coating is characterized by an overall intrinsic viscosity of about 0.60 dl/g or greater under melted conditions.

15. The invention as recited in claim 14, wherein the thermoplastic coating is characterized by a melting point in the range of about 155 degrees C. to about 230 degrees C.

16. The invention as recited in claim 14, wherein the polyester fibers comprise a first polyester polymer and wherein the thermoplastic coating comprises a blend of said first polyester polymer in combination with an effective amount of an isomer of said first polyester polymer such that the thermoplastic coating is characterized by a melting point in the range of about 155 degrees C. to about 230 degrees C.

17. The invention as recited in claim 16, wherein the textile substrate comprising the base textile layer and the thermoplastic coating is characterized by an overall intrinsic viscosity of about 0.64 dl/g or greater under melted conditions.

18. The invention as recited in claim 17, wherein the first polyester polymer is a terephthalic acid polyester polymer.

19. The invention as recited in claim 18, wherein the thermoplastic coating comprises a blend of a terephthalic acid polyester polymer in combination with an isophthalic acid polyester polymer.

20. The invention as recited in claim 19, wherein the thermoplastic coating comprises about 30 percent of said isophthalic acid polyester polymer.

21. A process for recycling of a coated textile substrate used in the manufacture of foot wear comprising the steps of:
forming a base textile layer of polymeric fiber;
applying a thermoplastic coating across at least one surface of the base textile to form a coated substrate;
cutting a plurality of fabric blanks from the coated substrate;
collecting scrap portions of the coated substrate;
processing the scrap portions to form recycled feed stock for melt spinning;
optionally blending the recycled feed stock with other polymeric material;
extruding recycled polymeric fiber from the recycled feed stock; and
thereafter repeating the forming step using the recycled polymeric fiber.

22. The process as recited in claim 21, wherein the base textile layer comprises at least a percentage of polyester fibers, said polyester fibers having a first glass transition temperature and wherein the thermoplastic coating is a co-polyester having a second glass transition temperature below the first glass transition temperature, and wherein the coated substrate is characterized by an overall intrinsic viscosity of about 0.60 dl/g or greater under melted conditions.

23. The invention as recited in claim 22, wherein the thermoplastic coating is characterized by a melting point in the range of about 155 degrees C. to about 230 degrees C.

24. The invention as recited in claim 22, wherein the polyester fibers comprise a first polyester polymer and wherein the thermoplastic coating comprises a blend of said first polyester polymer in combination with an effective amount of an isomer of said first polyester polymer such that the thermoplastic coating is characterized by a melting point in the range of about 155 degrees C. to about 230 degrees C.

25. The invention as recited in claim 24, wherein the coated substrate is characterized by an overall intrinsic viscosity of about 0.64 dl/g or greater under melted conditions.

26. A modular assembly station for laminating a coated substrate material to a second material, the assembly station comprising a substantially circular rotatable work top and a selectively activatable hot press adapted to contact one half of the work top while parts for lamination are placed across the other half of the work top.
